(19) United States
(12) Patent Application Publication
(10) Pub. No.: US 2014/0304285 A1
(43) Pub. Date: Oct. 9, 2014

(54) TERMINAL AND METHOD FOR MANAGING FILES ASSOCIATED WITH AN APPLICATION

(71) Applicant: Pantech Co., Ltd., Seoul (KR)

(72) Inventors: Sun Hee AN, Seoul (KR); Soo Kyoung Sohn, Seoul (KR); Su Young Lee, Seoul (KR)

(73) Assignee: Pantech Co., Ltd., Seoul (KR)

(21) Appl. No.: 14/223,394

(22) Filed: Mar. 24, 2014

(30) Foreign Application Priority Data
Apr. 5, 2013 (KR) 10-2013-0037209

(51) Int. Cl. G06F 17/30

(52) U.S. Cl. CPC G06F 17/30091
USPC 707/756

(57) ABSTRACT

Provided is a method and a terminal for processing a file created or stored in the terminal. A terminal to process a file includes a display request determiner configured to determine whether to request displaying of a file or a folder associated with an application; a database processor configured to manage an ownership database configured to map the file or folder with the application; a file access controller configured to control access to the file or folder based on the ownership database; and a display unit configured to display information about the file or folder, wherein the file access controller grants access to the displayed information.

### CROSS-REFERENCE TO RELATED APPLICATION

This application claims priority from and the benefit of Korean Patent Application No. 10-2013-0037209, filed on Apr. 5, 2013, which is hereby incorporated by reference in its entirety for all purposes as if fully set forth herein.

### BACKGROUND

1. Field

Exemplary embodiments relate to a method and a terminal for processing a file created or stored in the terminal from a perspective of an application.

2. Discussion of the Background

In the case of a smart phone, even though a large number of applications are installed and used by many users, a user may not easily verify a file or a folder associated with an application excluding reviewing an execution icon for executing the application.

The user may verify an association of a file or a folder with an application through a separate file manager program, but the smart phone is generally designed in a structure in which it is difficult for the user to verify a file or a folder associated with an application.

Accordingly, the user may have difficulty in verifying the file or the folder associated with the application, and a method and terminal for verifying file associations is desired.

### BRIEF SUMMARY

Aspects of the present invention provide a method and a terminal for processing a file created or stored in the terminal from a perspective of an application.

Additional features of the invention will be set forth in the description that follows, and in part will be apparent from the description, or may be learned by practice of the invention.

According to exemplary embodiments of the present invention, there is provided a terminal to process a file, the terminal including: a display request determiner configured to determine whether to request displaying of a file or a folder associated with an application; a database processor configured to manage an ownership database configured to map the file or folder with the application; a file access controller configured to control access to the file or folder based on the ownership database; and a display unit configured to display information about the file or folder, wherein the file access controller grants access to the display information.

According to exemplary embodiments of the present invention, there is provided a method for processing a file, the method comprising: determining whether to request displaying of a file or a folder associated with an application; storing in a ownership database a mapping of the file or folder with the application; controlling access to the file or folder based on the ownership database; and displaying information about the file or folder.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram of a terminal to process a file associated with an application according to exemplary embodiments.

FIG. 2 is a block diagram of a terminal to process a file associated with an application according to exemplary embodiments.

FIG. 3 is a flowchart illustrating a method of processing a file associated with an application at a terminal according to exemplary embodiments.

FIG. 4, FIG. 5, FIG. 6 and FIG. 7 are flowcharts illustrating a method of processing a file associated with an application at a terminal according to exemplary embodiments.

FIG. 8A, FIG. 8B and FIG. 8C are exemplary user interfaces illustrating a process of displaying a file associated with an application according to exemplary embodiments.

FIG. 9A and FIG. 9B illustrate an access result when overlapping of an ownership is allowed in a method of processing a file associated with an application at a terminal according to exemplary embodiments.

FIG. 10 illustrates an access result when overlapping of an ownership is disallowed in a method of processing a file associated with an application at a terminal according to exemplary embodiments.

FIG. 11A, FIG. 11B and FIG. 11C illustrate a user interface when a terminal to process a file associated with an application displays a file or a folder associated with an application on a page for editing a plurality of applications according to exemplary embodiments.

FIG. 12A, FIG. 12B and FIG. 12C illustrate a user interface when a terminal to process a file associated with an application deletes an application on a page for editing a plurality of applications according to exemplary embodiments.

FIG. 13A and FIG. 13B illustrate a user interface when a terminal to process a file associated with an application deletes an application being executed according to exemplary embodiments.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first,” “second,” and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

Embodiments described in the specification are wholly hardware, and may be partially software or wholly software. In the specification, “unit”, “module”, “device”, “system”, or the like represents a computer related entity, such as, hardware, combination of hardware and software, or software. For example, in the specification, the unit, the module, the device, the system, or the like may be an executed process, a processor, an object, an executable file, a thread of execution, a program, and/or a computer, but are not limited thereto. For example, both of an application which is being executed in the computer and a computer may correspond to the unit, the module, the device, the system, or the like in the specification.

It will be understood that when an element is referred to as being “connected to” another element, it can be directly connected to the other element, or intervening elements may be present.

Hereinafter, exemplary embodiments will be described with reference to the accompanying drawings.

In general, a mobile device may include a hardware layer, a platform to process a signal input from the hardware layer and to transfer the processed input signal, and an application program layer operating on the platform and including various types of application programs.

A platform may be classified into ANDROID platform, WINDOWS mobile platform, iOS platform, and the like, based on an Operating System (OS) of a mobile device. Each platform may have a different structure, but may have similar or identical basic functionality.

The ANDROID platform manages various types of hardware, and may include a LINUX kernel layer to transfer a request of an application program to hardware, and to transfer a response of the hardware to the application program, a library layer, coded in for example C or C++, to connect hardware and a framework layer, and the framework layer to manage various types of application programs.

In the case of the WINDOWS mobile platform, a WINDOWS core layer corresponds to the LINUX kernel layer. The WINDOWS mobile platform may include an interface layer to connect the WINDOWS core layer and an application program layer, and to support various types of languages and functions.

In the case of the iOS platform, a core OS layer corresponds to the LINUX kernel layer. A core service layer may be similar to the library layer and the framework layer. The iOS platform may include a media layer to provide a multimedia function and a COCOA touch layer to serve as a layer for various types of applications.

Herein, each layer may be expressed as a block, and the framework layer and a similar layer corresponding thereto may be defined as a software block. The following exemplary embodiments may be configured on a variety of platforms of a mobile device, but are not limited to the aforementioned platform types.

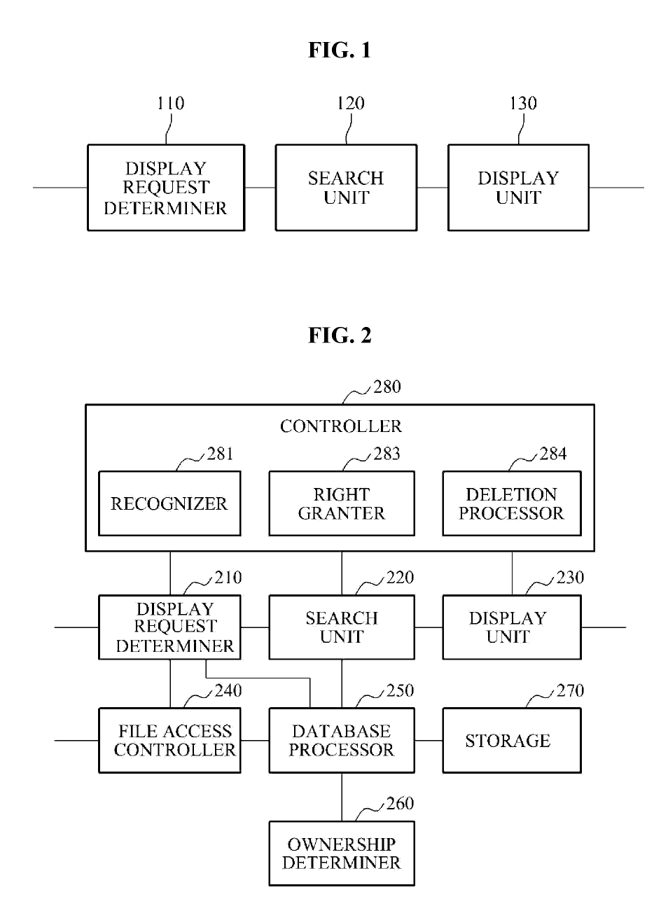

FIG. 1 is a block diagram of a terminal to process a file associated with an application according to exemplary embodiments.

Referring to FIG. 1, the terminal for processing a file associated with an application may include a display request determiner 110, a search unit 120, and a display unit 130.

The display request determiner 110 may determine whether to request displaying of a file or a folder associated with an application. Whether to request displaying of the file or the folder associated with the application may be determined based on whether a search request for the file or the folder associated with the application is received. When a user input, for example, a touch input, is performed on a search icon, the display request determiner 110 may determine that the search request is received.

The search request may be recognized when a user input is received by the application the search unit 120 is activated in response to the user input. The user input may include a touch input, a gesture or motion input, a voice input, or the like.

The search unit 120 may search for a file or a folder associated with an application corresponding to the display request. The file or the folder associated with the application may indicate a file or a folder that has been accessed by the application. Here, access may include “create,” “execute,” “install,” and “delete.” The search unit 120 may search for the file or the folder that has been accessed by the application.

For example, an access history to a file or a folder may be defined as a concept of ownership. For example, a priority of ownership may increase according to an increase in the number of accesses for each file or folder. The priority of ownership for each file or folder may be stored in an ownership database.

For example, when overlapping of an ownership on a file or a folder is allowed, a plurality of applications having an ownership may be found. In contrast, when overlapping of an ownership is disallowed, only an application having the top priority may be found, and the remaining applications that access the file or folder may not be determined.

The search unit 120 may search and ownership database for a file or a folder on which an application corresponding to the display request has the ownership. The ownership database may include a database to store information of an application having an ownership on each file or folder stored in the terminal. That an application has an ownership on a file or a folder indicates that the application is associated with a creation, an execution, and a deletion of the file or folder.

For example, when a file or a folder is created, deleted, or executed by an application, the file or folder may be mapped to the application and the mapping may be stored in the ownership database. A count value may be assigned for each file or folder every time the application accesses the file or folder. For example, when an application accesses a file, a count value may increase by “1” in a table in which the file and the application are mapped. In addition, when the application creates the file, a count value may be set to a value “N” in a table in which the file and the application are mapped. An association level between a file and an application may be indicated based on a count value.

The ownership database may include identification information of an application, identification information of a file or a folder, and a count value, all of which may be mapped and thereby be stored in the ownership database, for example, as a table.

The search unit 120 may search for a file or a folder on which an application corresponding to the display request has the ownership by searching the ownership database. The search unit 120 may search for identification information of a file or a folder that matches identification information of the application.

The display unit 130 may display the found file or folder on a screen of the terminal. A user may obtain information about the file or the folder associated with the application by verifying the file or the folder on which the application interested in by the user has the ownership.

For example, the search unit 120 may search for a file or a folder on which an application has a first ownership, based on a count value of the ownership database, and the display unit 130 may display the found file or folder on the screen. For example, a plurality of applications may have an ownership with respect to a single file. In this example, an application having a largest count value may be determined to have a first ownership on the corresponding file. As another example, orders of applications having a first ownership, a second ownership, a third ownership, and the like may be determined for each file based on a count value.

The search unit 120 may search for a file or a folder on which an application has a first ownership. In some embodiments, the search unit 120 may search for files or folders on which an application has the first ownership and a second ownership. A search range may be determined based on settings of a system or a user.

FIG. 2 is a block diagram of a terminal to process a file associated with an application according to exemplary embodiments.

Referring to FIG. 2, the terminal for processing a file associated with an application may include a display request determiner 210, a search unit 220, a display unit 230, a file access controller 240, a database processor 250, an ownership determiner 260, a storage 270, and a controller 280.

The display request determiner 210 may determine whether to request displaying of a file or a folder associated with an application. Whether to request displaying of the file or the folder associated with the application may be determined based on whether a search request for the file or the folder associated with the application is received. When a user input is received, for example, a touch input is sensed on a search icon, it may be determined that the search request has been received.

The search request may be initiated by recognizing a user input in the application or the search unit 220 may be activated in response to the user input. The user input may be received via a touch input, a gesture or motion input, a voice input, or the like.

The search unit 220 may search for a file or a folder associated with an application. The file or the folder associated with the application may indicate a file or a folder that has been accessed by the application. Here, the access type may include a “create,” “execute,” “delete” or the like. The search unit 220 may search for the file or the folder that has been accessed by the application.

The search unit 220 may search the ownership database for a file or a folder on which an application has an ownership. A file or a folder created, deleted, or executed by the application may be mapped to the application and thereby the association between the file and the application may be stored in the ownership database. In addition, a count value may be assigned or incremented for each file or folder every time the application accesses a file or folder. For example, when an application accesses a file, a count value may increase by “1” in a table in which the file and the application are mapped. For example, identification information of an application, identification information of a file or a folder, and a count value may be mapped and thereby be stored as a table in the ownership database.

The search unit 220 may search for a file or a folder on which an application has an ownership by searching the ownership database for identification information of a file or a folder that matches identification information of the application.

The display unit 230 may display the found file or folder on the screen. A user may obtain information about the file or the folder associated with the application by verifying that the application has the ownership of the file or the folder in which it is interested.

The file access controller 240 may serve to control the overall access, such as install, create, and execute a file or a folder in the terminal.

For example, when an application is installed, the file access controller 240 may create an installation file and an installation folder of the application.

The database processor 250 may manage, for example, by creating and updating, an application database, a file database, and the ownership database. For example, in the case of booting the terminal, the database processor 250 may create and update the application database, the file database, and the ownership database.

The application database may include identification information of the installed application or applications. The display request determiner 210 may obtain or be provided identification information of the application when installing the application. For example, identification information of the application may include a name of the application, an identifier (ID) of the application, a downloaded date and time of the application, an access date and time of the application, a provider of the application, an installation date and time of the application, or the like.

For example, the database processor 250 may create the application database by assigning a number to identification information of the application. For example, when identification information is a name of the application, the number “1” may be assigned as a name to a gallery application and the number “2” may be assigned as a name to a message application.

The file database may include identification of a file or a folder stored in the terminal. For example, the file database may include identification of a file or a folder created through the application. The file database may include identification information of a file or a folder stored from an outside of the terminal. For example, identification information of a file or a folder may include a name of the file or the folder, a storage location of the file or the folder, and a filename extension.

The data processor 250 may create the application database by assigning a number to identification information of a file or a folder. For example, when the identification information is a storage location “/storage/sdcard0/DCIM/Camera/IMG_{—}1234.jpg” of the file or the folder, number “1” may be assigned to the storage location.

The ownership database may include a result of mapping identification information of an application and identification of a file or a folder. For example, a result of mapping a gallery application and “/storage/sdcard0/DCIM/Camera/IMG_{—}1234.jpg” may be included in the ownership database. In addition, a result of mapping number “1” assigned to a gallery application and number “1” assigned to “/storage/sdcard0/DCIM/Camera/IMG_{—}1234.jpg” may be included in the ownership database.

The ownership database may include a count value. The count value may be used as a criterion indicating an importance level of a relationship between each application and each folder. For example, to apply an access result of an application, a count value may increase by “1” in a folder accessed by the application. As another example, to apply a creation result of an application, a count value may be set to “10” in a file created by the application. A file or a folder created by an application is highly likely to be accessed by the application and thus, a relatively large value may be set for the initial or at creation count value. An increment value and a setting value of the count value may vary based on settings of a system or a user.

For example, in response to a display request for a file or a folder associated with an application, the search unit 220 may search for identification information of a file or a folder accessed by the application.

The database processor 250 may create the ownership database by mapping identification information of the application and identification information of the found file or folder. For example, the database processor 250 may create the ownership database by mapping a number assigned to identification information of the application and a number assigned to identification information of the found file or folder.

In addition, when the same file or folder is accessed by the same application in a state in which identification information of the same application and identification information of the same file or folder are mapped, the database processor 250 may update the ownership database by increasing a count value.

For example, in the case of executing a file “IMG_{—}1234.jpg” of “/storage/sdcard0/DCIM/Camera/IMG_{—}1234.jpg” through a gallery application in a state in which the gallery application and “/storage/sdcard0/DCIM/Camera/IMG_{—}1234.jpg” are mapped, a count value may increase by “1.”

For example, the database processor 250 may create the ownership database by mapping identification information of an installed application and identification information of an installation file and an installation folder.

For example, the database processor 250 may create the ownership database by mapping identification information of an application and identification information of a file executed or executable in the application.

For example, the database processor 250 may create the ownership database by mapping identification information of an application and identification information of a file created during execution of the application.

For example, the database processor 250 may set a first weight as a count value in the file created during the execution of the application in the ownership database, and may increase the set count value when mapping is performed again with respect to a file stored in the ownership database. For example, “10” may be set as the first weight.

The ownership determiner 260 may determine an application having a first ownership for each file stored in the ownership database, based on a count value. A plurality of applications may be mapped to the same file. In this example, an ownership priority of the file may be determined based on a count value.

When an application is deleted, the file access controller 240 may delete an installation file and an installation folder of the deleted application.

The database processor 250 may delete identification information of the deleted application from the application database. The database processor 250 may delete identification information of the deleted installation file and installation folder from the file database. The database processor 250 may delete identification information of the deleted application and identification information of the deleted installation file and installation folder from the ownership database.

The storage unit 270 may store the application database, the file database, and the ownership database.

The controller 280 may determine whether another application may also have an ownership on a file or a folder. The controller 280 may determine whether to allow an overlapping ownership with respect to a single file or folder. The controller 280 may determine whether overlapping of an ownership is available based on settings of a user or settings of a system.

For example, when an overlapping ownership on a file or a folder is allowed, all of the applications mapped for each file in the ownership database may have an ownership on the corresponding file. In this example, an ownership priority of the corresponding file may be determined based on a count value. For example, a first ownership, a second ownership, and a third ownership may be determined based on a count value.

When an overlapping ownership on a file or a folder is disallowed, only an application having the largest count value among applications mapped for each file in the ownership database may have an ownership on the corresponding file.

When the controller 280 determines that the other application may also have an ownership on a file or a folder, the display unit 230 may display a file or a folder found by the search unit 220 and information about the other application having an ownership on the found file or folder.

The controller 280 may include a recognizer 281, a right granter 283, and a deletion processor 284.

The recognizer 281 may recognize a selection input of an application on a page of the terminal for displaying a plurality of applications. The selection input may correspond to a user input, for example, a touch input, a gesture or motion input, and a voice input.

The display unit 230 may display a setting window for setting whether to search for a file or a folder associated with the application in response to the recognized selection input of the application. The display unit 230 may display the file or the folder associated with the application in response to a search request input recognized on the setting window.

The recognizer 281 may recognize a selection input of an application on a setting page of the terminal for editing a plurality of applications. The selection input may correspond to a user input, for example, a touch input, a gesture or motion input, and a voice input.

The display unit 230 may display a selection window for determining whether to delete a file or a folder associated with the application in response to the recognized selection input of the application.

The right granter 283 may grant the application a right to delete a file or a folder on which the application has a first ownership. Whether to grant such right may be determined based on settings of a user or a system.

In response to an input for deleting a file or a folder that may be deleted from the application granted with the right, the deletion processor 284 may delete the corresponding file or folder. The deletion processor 284 may delete the corresponding file or folder in interaction with the file access controller 240.

When booting the terminal, the display request determiner 210, the database processor 250, and the ownership determiner 260 may be executed. The display request determiner 210 may manage applications in order to verify whether a display request for an application installed in the terminal is received. The database processor 250 may create and manage various types of databases. The database processor 250 may determine an ownership on a file or a folder.

Hereinafter, creation and update of a file database will be described.

For example, when the database processor 250 is executed, the file database may be created by calling the storage 270 and file information may be updated in the file database through the storage 270 while searching a file system within the terminal through the search unit 220.

Hereinafter, creation and update of an application database will be described

For example, information created when installing an application may be stored in an Extensible Mark-up Language (XML) file. Here, the display request determiner 210 may create the application database by calling the storage unit 270, and may update the application database with a name of the application included in information being parsed through the storage unit 270. For example, the application database may be created and updated without intervention of the database processor 250.

Hereinafter, creation and update of an ownership database will be described.

For example, when the database processor 250 is executed, the ownership database may be created and be updated based on a condition in the case of installing, executing, and deleting an application.

The controller 280 may provide/perform the overall control of the terminal for processing a file associated with an application, and may provide/perform the functionality of the display request determiner 210, the search unit 220, the display unit 230, the file access controller 240, the database processor 250, the ownership determiner 260, and the storage 270. Exemplary constituent elements are separately illustrated in FIG. 2 to describe each function thereof. Accordingly, all or some of the constituent elements may be configured to be processed in the controller 280.

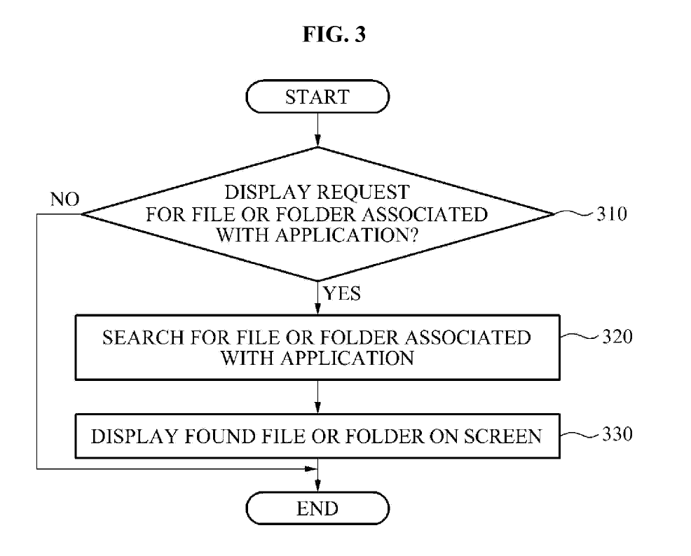

FIG. 3 is a flowchart illustrating a method of processing a file associated with an application at a terminal according to exemplary embodiments. The description made above with reference to FIGS. 1 and 2 may be applied alike to the method of FIG. 3.

In operation 310, a terminal according to exemplary embodiments may determine whether to request displaying of a file or a folder associated with an application. Whether to request displaying of the file or the folder associated with the application may be determined based on whether a search request for the file or the folder associated with the application is received. When a user input, for example, a touch input, is performed on a search icon, operation 310 may determine that the search request has been received.

In operation 320, in response to the received display request, the terminal may search for the file or the folder associated with the application.

The terminal may search an ownership database for a file or a folder on which the application corresponding to the display request has an ownership. A file or a folder created, deleted, or executed by an application may be mapped to the application and be stored in the ownership database. A count value may be assigned for each file or folder when, for example, every time, the application accesses a corresponding file or folder. For example, when an application accesses a file, a count value may increase by “1” in a table that maps the file and the application. For example, identification information of an application, identification information of a file or a folder, and a count value may be mapped and stored in the ownership database, for example, in a table.

In operation 330, the terminal may display the found file or folder on the screen.

The terminal may search for a file or a folder on which an application corresponding to a display request has a first ownership based on an associated count value of the ownership database, and may display the found file or folder on the screen.

The terminal may determine whether another application may also have an ownership on the found file or folder. When it is determined that the other application may also have an ownership on the found file or the folder, the terminal may display the found file or folder and information about the other application having an ownership on the found file or folder.

When an application is installed, the terminal may create an installation file and an installation folder of the application. The terminal may create an ownership database by mapping an application database including identification information of the installed application and a file database including identification information of the installation file and the installation folder to identification information of the installed application and identification information of the installation file and the installation folder, respectively.

The terminal may create the ownership database by mapping identification information of an application and identification information of a file executed or executable in the application.

The terminal may create the ownership by mapping identification information of an application and identification information of a file created during execution of the application.

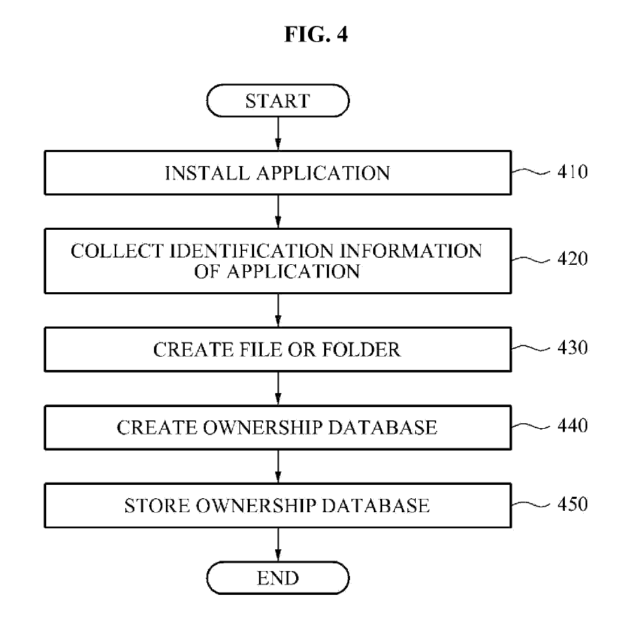

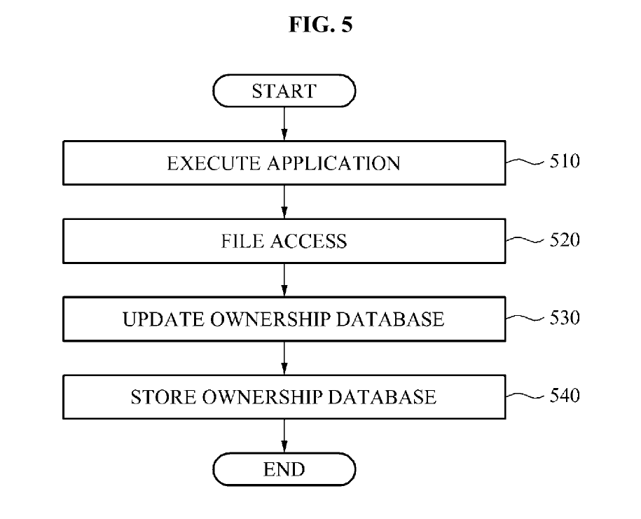

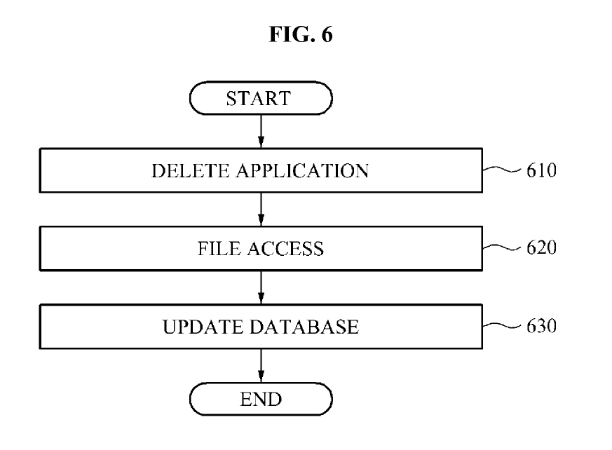

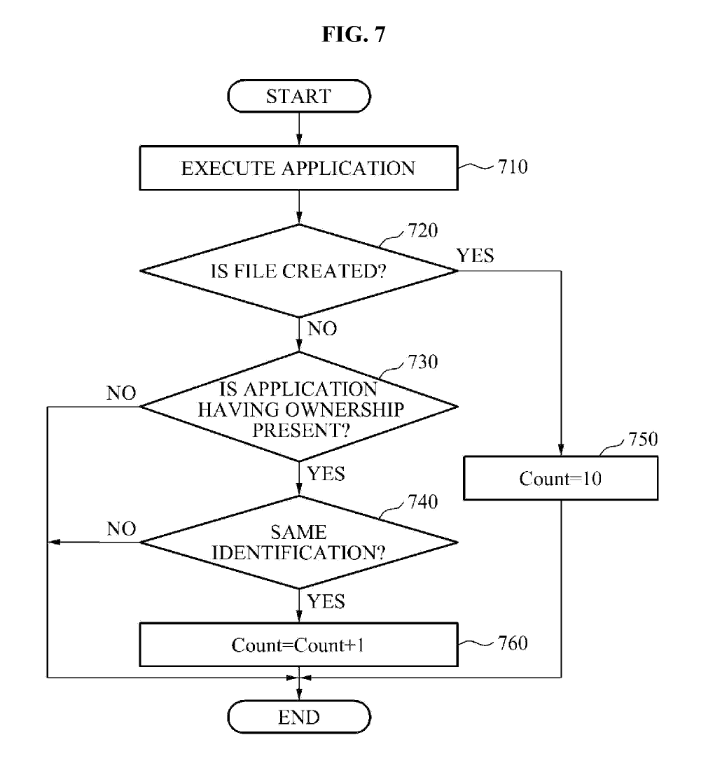

FIG. 4, FIG. 5, FIG. 6 and FIG. 7 are flowcharts illustrating a method of processing a file associated with an application at a terminal according to exemplary embodiments.

Referring to FIG. 4, in operation 410, the terminal may install an application.

In operation 420, the terminal may collect identification information of the application. The terminal may collect name information of the application included in information of the application and may update the collected name information to an application database.

For example, when a user installs an application with a name of “Test App” in the terminal, the application database may be updated as illustrated in Table 1. The terminal may assign an “appid” to a name of each application. Referring to Table 1, “appid” assigned to “Test App” is “8.”

TABLE 1

| appid [symbol] | appname [symbol] | [symbol] |
|---|---|---|
| 1 [symbol] | Gallery [symbol] | [symbol] |
| 2 [symbol] | Music Player [symbol] | [symbol] |
| 3 [symbol] | Video Player [symbol] | [symbol] |
| 4 [symbol] | Doc Viewer [symbol] | [symbol] |
| 5 [symbol] | Voice Recorder [symbol] | [symbol] |
| 6 [symbol] | Quickpic [symbol] | [symbol] |
| 7 [symbol] | Melon [symbol] | [symbol] |
| 8 [symbol] | Test App [symbol] | [symbol] |

In operation 430, the terminal may create a file or a folder associated with installation together with installation of the application. The terminal may update information “/storage/sdcard0/data/data/com.android.testapp/” including a file “/storage/sdcard0/data/data/com.android.testapp/testapp.xml” about the created file or folder to a file database. For example, the file database may be configured as illustrated in Table 2. The terminal may assign a “fileid” to information about each file or folder. Referring to Table 2, the “fileid” assigned to the folder “/storage/sdcard0/data/data/com.android.testapp/” is “10” and the “fileid” assigned to the file “/storage/sdcard0/data/data/com.android.testapp/testapp.xml” is “11”

TABLE 2

| Fileid | Data |
|---|---|
| 1 | /storage/sdcard0/Pictures/1978.png |
| 2 | /storage/sdcard0/DCIM/Camera/IMG_1234.jpg |
| 3 | /storage/sdcard0/DCIM/Camera/IMG_1256.jpg |
| 4 | /storage/sdcard0/DCIM/Camera/IMG_1256.avi |
| 5 | /storage/sdcard0/music/2NE1-I Love you.mp3 |
| 6 | /storage/sdcard0/music/T-memoreis.mp3 |
| 7 | /storage/sdcard0/oldpop/beatles-yesterday.mp3 |
| 8 | /storage/sdcard0/oldpop/beatles-heyjude.mp3 |
| 9 | /storage/sdcard0/oldpop/abba/dancing queen.mp3 |
| 10 | /storage/sdcard0/data/data/com.android.testapp/ |
| 11 | /storage/sdcard0/data/data/com.android.testapp/testapp.xml |

In operation 440, the terminal may obtain information about a file or a folder created together when installing the application by parsing an XML file created when installing the application. The terminal may create an ownership database by mapping the “appid” of the application database and the “fileid” of the file database. For example, the ownership database may be provided to have a configuration as illustrated in Table 3.

The terminal may create the ownership database by mapping “appid 8” to each of “fileid 10” and “fileid 11” with respect to “Test App.” An “id” of the ownership database may be assigned to each mapping result. In addition, the terminal may set a count value of each of a file and a folder newly created to be “10.”

TABLE 3

| id | fileid | appid | count |
|---|---|---|---|
| 1 | 1 | 1 | 10 |
| 2 | 2 | 4 | 1 |
| 3 | 5 | 2 | 11 |
| 4 | 6 | 2 | 10 |
| 5 | 6 | 7 | 28 |
| 6 | 10 | 8 | 10 |
| 7 | 11 | 8 | 10 |

In operation 450, the terminal may store the created ownership database.

Referring to FIG. 5, in operation 510, the terminal may execute an application.

The terminal may search a file database for information about a file available in the application. For example, the terminal may search the file database for information about the file using a filename extension of the file available in the application.

For example, when a user executes a music playback application, music files playable back in the music playback application may be found from the file database. Information about the found music files may be provided in a configuration of Table 4.

TABLE 4

| fileid | data |
|---|---|
| 5 | /storage/sdcard0/music/2NE1-I Love you.mp3 |
| 6 | /storage/sdcard0/music/T-memoreis.mp3 |
| 7 | /storage/sdcard0/oldpop/beatles-yesterday.mp3 |
| 8 | /storage/sdcard0/oldpop/beatles-heyjude.mp3 |
| 9 | /storage/sdcard0/oldpop/abba/dancing queen.mp3 |

In operation 520, the terminal may determine that the music playback application is accessible to the found music files of Table 4.

In operation 530, the terminal may update the ownership database by mapping “appid 2 (see table 1) of the music playback application to each of “fileid 5”, “fileid 6”, “fileid 7”, “fileid 8”, and “fileid 9” of the found music files.

The terminal may start an ownership operation. For example, the terminal may calculate a current value of the ownership database. The terminal may search the ownership database for a list that satisfies “appid” and “fileid” fields. A count value may increase if a matching list is present as a search result and otherwise, a new list may be added.

Referring to Table 5, a previously created list 3 of “fileid 5” and list 4 of “fileid 6” are available with respect to “appid 2” and thus, the terminal may increase a count value of the list 3 to be from “11” to “12”, and may increase a count value of the list 4 to be from “10” to “11”. The terminal may add new lists 8, 9, and 10 with respect to fileid 7, 8, and 9. In this example, a file is not created by the music playback application and a playable file is found from among existing stored files and thus, a count value may be set to “1.”

TABLE 5

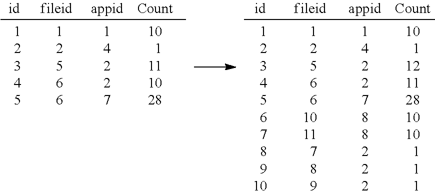

As another example of a file access, in operation 520, the terminal may create a new file during execution of the application. Information of the new file may be updated to the file database.

For example, when a user creates “130101_{—}202213.amr” by executing a voice recording application, the file database may be updated as shown in Table 6.

TABLE 6

| fileid | Data |
|---|---|
| 1 | /storage/sdcard0/Pictures/1978.png |
| 2 | /storage/sdcard0/DCIM/Camera/IMG_1234.jpg |
| 3 | /storage/sdcard0/DCIM/Camera/IMG_1256.jpg |
| 4 | /storage/sdcard0/DCIM/Camera/IMG_1256.avi |
| 5 | /storage/sdcard0/music/2NE1-I Love you.mp3 |
| 6 | /storage/sdcard0/music/T-memoreis.mp3 |
| 7 | /storage/sdcard0/oldpop/beatles-yesterday.mp3 |
| 8 | /storage/sdcard0/oldpop/beatles-heyjude.mp3 |
| 9 | /storage/sdcard0/oldpop/abba/dancing queen.mp3 |
| 10 | /storage/sdcard0/data/data/com.android.testapp/ |
| 11 | /storage/sdcard0/data/data/com.android.testapp/testapp.xml |
| 12 | /storage/sdcard0/voicerecorder/voicerec/130101_202213.amr |

In operation 530, the terminal may update the ownership database by mapping “appid 5 (see Table 1)” of the voice recording application and “fileid 12” among the found files. The terminal may also add a new list 11. In this example, when the voice recording application creates “130101_{—}202213.amr,” a count value may be set to “10.”

When the file is created, proximity between the file and the application may be determined to be high and a weight may be assigned and a count value for the application may be set to “10.”

An exemplary updated ownership database is illustrated in Table 7.

TABLE 7

| id | fileid | appid | count |
|---|---|---|---|
| 1 | 1 | 1 | 10 |
| 2 | 2 | 4 | 1 |
| 3 | 5 | 2 | 12 |
| 4 | 6 | 2 | 11 |
| 5 | 6 | 7 | 28 |
| 6 | 10 | 8 | 10 |
| 7 | 11 | 8 | 10 |
| 8 | 7 | 2 | 1 |
| 9 | 8 | 2 | 1 |
| 10 | 9 | 2 | 1 |
| 11 | 12 | 5 | 10 |

In operation 540, the terminal may store the updated ownership database.

Referring to FIG. 6, in response to a request for deleting an application from a user, the terminal may delete the corresponding application.

When creating the application, the terminal may obtain information of a file or a folder newly created by parsing a created XML file. The terminal may delete a list including a name of the deleted application from an application database. For example, referring to Table 8, in the case of deleting “Test App”, a list of “appid 8” may be deleted from the application database.

TABLE 8

| appid | appname |
|---|---|
| 1 | Gallery |
| 2 | Music Player |
| 3 | Video Player |
| 4 | Doc Viewer |
| 5 | Voice Recorder |
| 6 | Quickpic |
| 7 | Melon |
| 8 | Test App |

In operation 620, the terminal may delete a file or a folder from the terminal based on information obtained by parsing the XML file, and may delete a list of deleted files or folders from a file database. Referring to Table 9, lists for “fileid 10” and fileid 11″ may be deleted from the file database.

TABLE 9

| fileid | Data |
|---|---|
| 1 | /storage/sdcard0/Pictures/1978.png |
| 2 | /storage/sdcard0/DCIM/Camera/IMG_1234.jpg |
| 3 | /storage/sdcard0/DCIM/Camera/IMG_1256.jpg |
| 4 | /storage/sdcard0/DCIM/Camera/IMG_1256.avi |
| 5 | /storage/sdcard0/music/2NE1-I Love you.mp3 |
| 6 | /storage/sdcard0/music/T-memoreis.mp3 |
| 7 | /storage/sdcard0/oldpop/beatles-yesterday.mp3 |
| 8 | /storage/sdcard0/oldpop/beatles-heyjude.mp3 |
| 9 | /storage/sdcard0/oldpop/abba/dancing queen.mp3 |
| 10 | /storage/sdcard0/data/data/com.android.testapp/ |
| 11 | /storage/sdcard0/data/data/com.android.testapp/testapp.xml |
| 12 | /storage/sdcard0/voicerecorder/voicerec/130101_202213.amr |

In operation 630, the terminal may delete, from an ownership database, a list in which “appid” of the deleted application and “fileid” of the deleted file or folder are applied. Referring to Table 10, lists 6 and 7 may be deleted from the ownership database. The terminal may update the ownership database from which the lists 6 and 7 are deleted.

TABLE 10

| .id | fileid | appid | Count |
|---|---|---|---|
| 1 | 1 | 1 | 10 |
| 2 | 2 | 4 | 1 |
| 3 | 5 | 2 | 12 |
| 4 | 6 | 2 | 11 |
| 5 | 6 | 7 | 28 |
| 6 | 10 | 8 | 10 |
| 7 | 11 | 8 | 10 |
| 8 | 7 | 2 | 1 |
| 9 | 8 | 2 | 1 |
| 10 | 9 | 2 | 1 |
| 11 | 12 | 5 | 10 |

Referring to FIG. 7, in operation 710, a terminal according to exemplary embodiments may execute an application. In operation 720, the terminal may determine whether a file created by the application is being executed. For example, in the case of installing the application, an installation file and an installation folder may be created.

In operation 730, when the file is created, the terminal may determine whether a file or a folder on which the application has an ownership is present within the ownership database. When the file or the folder is present, the terminal may search for the file or the folder.

In operation 740, the terminal may verify whether a file or a folder having the same as identification information of the application corresponding to the received display request is present among the found files or folders. For example, the identification information may be a name or “appid” of the application.

In operation 750, the terminal may set a count value to be “10” in the ownership database with respect to the file created through the application.

In operation 760, when the file or the folder having the same identification information as identification information of the application being executed is present, the terminal may increase a count value of a list including identification information of the corresponding application and identification information of the file or the folder by “1” in the ownership database.

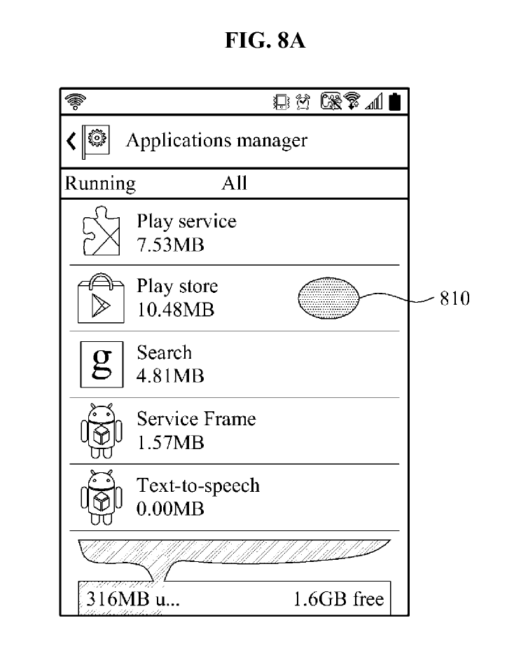

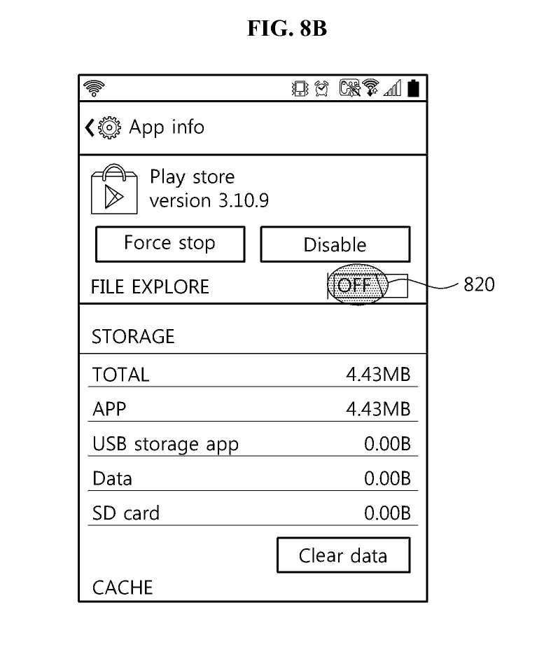

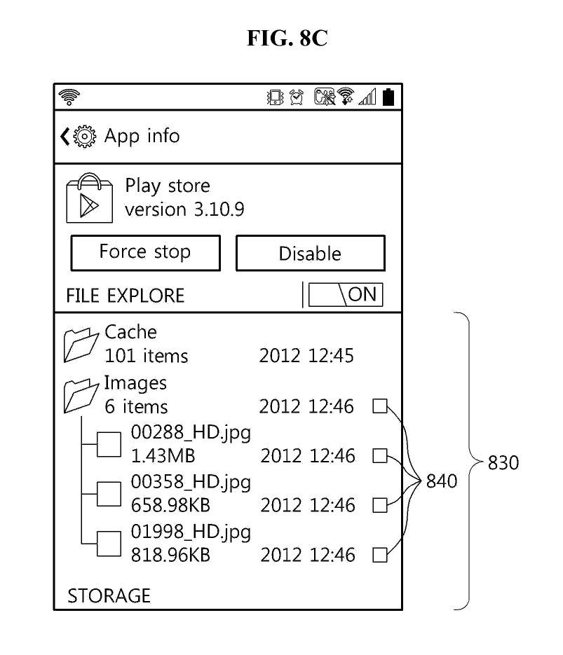

FIG. 8A, FIG. 8B and FIG. 8C are exemplary user interfaces illustrating a process of displaying a file associated with an application according to exemplary embodiments.

According to exemplary embodiments, it is possible to set an application having an ownership with respect to a file or a folder within the terminal. By classifying, for each application, a file or a folder on which an application has an ownership and by converting a current folder-based file system to an application based file system, it is possible to provide the converted application based file system to a user.

Referring to FIG. 8A, information about applications installed in the terminal may be provided to a user on a page “Settings>Applications manager” of the terminal.

For example, in response to a touch input 810 occurring on a GOOGLE PLAY STORE application on an application management page, a page of the screen may be changed with a page of FIG. 8B.

Referring to FIG. 8B and FIG. 8C, a setting window indicating whether “FILE EXPLORE” is associated with the GOOGLE PLAY STORE application and is available may be enabled with an input 820. When “FILE EXPLORE” “ON” is set on the setting window by the input 820, folders and files 830 associated with the GOOGLE PLAY STORE application may be displayed on the page. The terminal may collect, from an ownership database, information about a file or a folder created or executed by the application.

Check boxes 840 to select accessibility for each file or folder may be displayed. A file or a folder associated with an application may be accessible on an “App info” page of the GOOGLE PLAY STORE application.

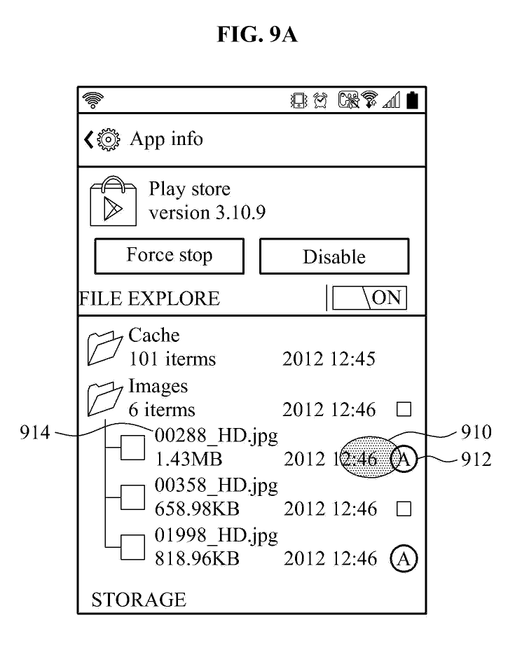

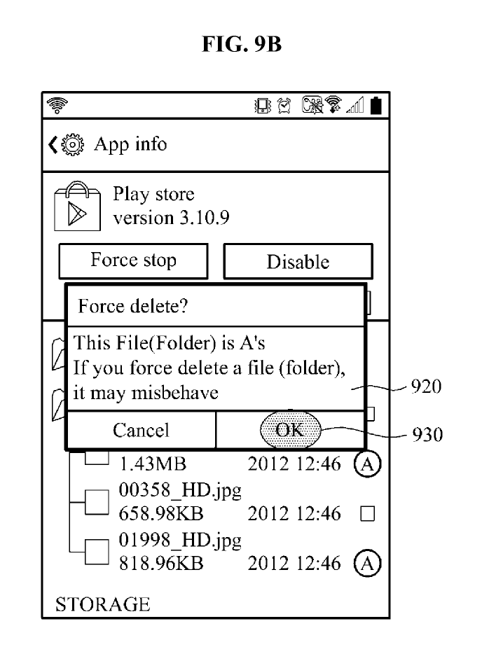

FIG. 9A and FIG. 9B illustrate an access result when overlapping of an ownership is allowed in a method of processing a file associated with an application at a terminal according to exemplary embodiments.

Referring to FIG. 9A, an information page of a GOOGLE PLAY STORE application displays information for a file 914 on which application A 912 has a first ownership, for example, when the file or folder 914 is accessed by the application. The first ownership may be determined based on a count value in an ownership database. The GOOGLE PLAY STORE application may have a relatively low priority ownership on the file 914 compared to the other application A.

Referring to FIG. 9B, in a case in which a deletion request is made, for example, by using input 910 corresponding to file 914 for which the application A 912 has a first ownership, is input through the GOOGLE PLAY STORE application, the file 914 may be managed by the application A 912 and thus, an information window 920 indicating that a malfunction of the application A 912 may occur may be displayed when the GOOGLE PLAY STORE application is requested to delete the file 914. In response to a selection input 930 of a user, the GOOGLE PLAY STORE application may delete the file 914. That is, information indicating that the file 914 is important in the relevant application (application A 912) may be provided through the information window 920.

As another example, the file 914 on which the application A 912 has a first ownership may be configured to deny file deletion from the GOOGLE PLAY STORE application.

As another example, even though the application A 912 has a relatively low priority ownership compared to the GOOGLE PLAY STORE application, information indicating that the application A 912 also has an ownership may also be displayed together with the file 914. When overlapping of an ownership is allowed, an application having a relatively high priority ownership on a file on which the GOOGLE PLAY STORE application has an ownership may also be displayed. An application having a relatively low priority ownership may also be displayed.

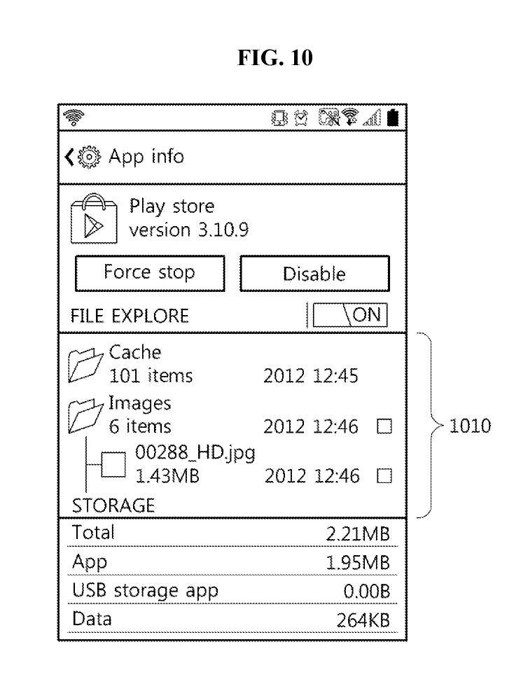

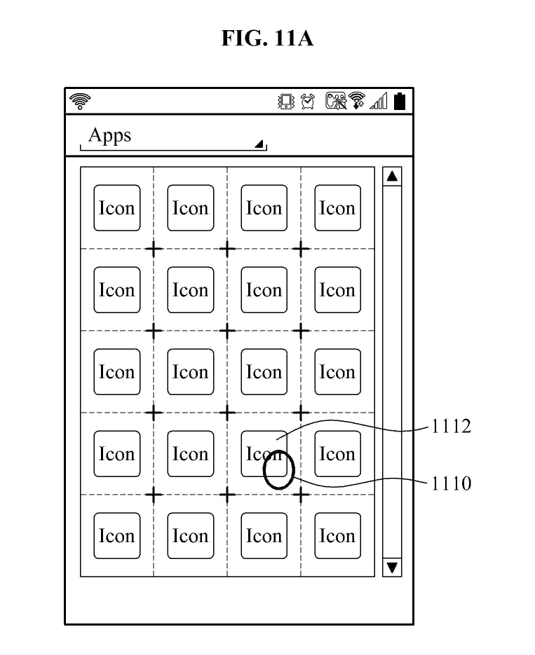

FIG. 10 illustrates an access result when overlapping of an ownership is disallowed in a method of processing a file associated with an application at a terminal according to exemplary embodiments.

Referring to FIG. 10, when overlapping of an ownership on a file or a folder is disallowed, only files and folders 1010 on which an application has an ownership may be displayed on an information page of a GOOGLE PLAY STORE application.

In this example, the ownership may be determined based on a count value of an ownership database. Only an application having the largest count value may be determined to have an ownership on a corresponding folder.

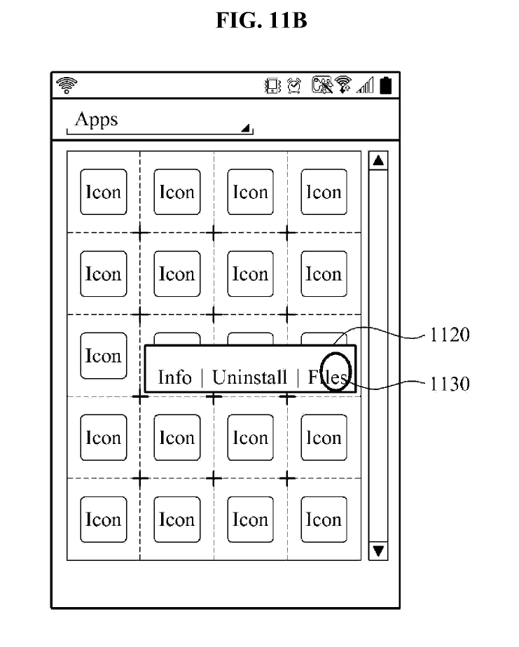

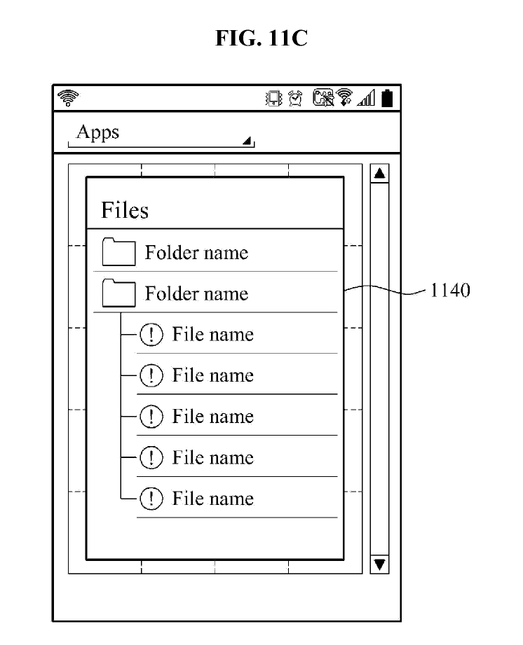

FIG. 11A, FIG. 11B and FIG. 11C illustrate a user interface when a terminal to process a file associated with an application displays a file or a folder associated with an application on a page for editing a plurality of applications according to exemplary embodiments.

Referring to FIG. 11A, applications currently installed in the terminal may be verified on a screen for editing a plurality of applications. However, aspects need not be limited thereto such that fewer than all of the applications or a subset of the applications installed in the terminal may be verified on the screen.

In response to an input 1110 associated with an application 1112 from a listing of applications, a shortcut menu 1120 of the application 1112 may be displayed as illustrated in FIG. 11B. The shortcut menu 1120 may include menus for selecting information (Info), a deletion (Uninstall), a file or a folder (Files) accessed by the application 1112. In response to a user input 1130 recognized on “Files” in the shortcut menu 1120, files or folders accessed by the application 1112 may be displayed on a separate page 1140 as illustrated in FIG. 11C.

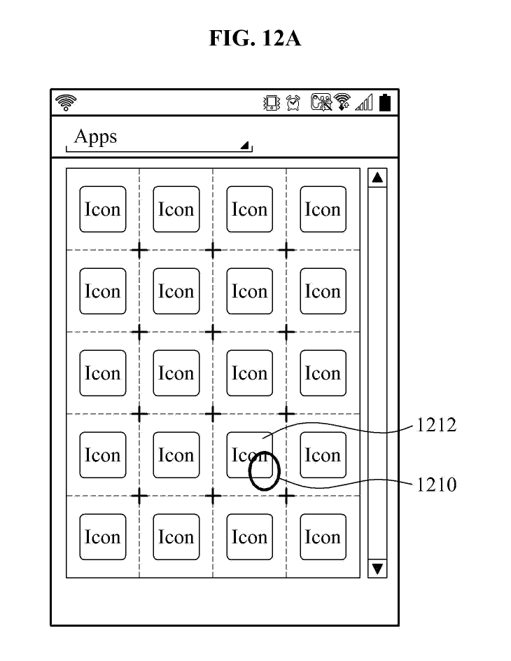

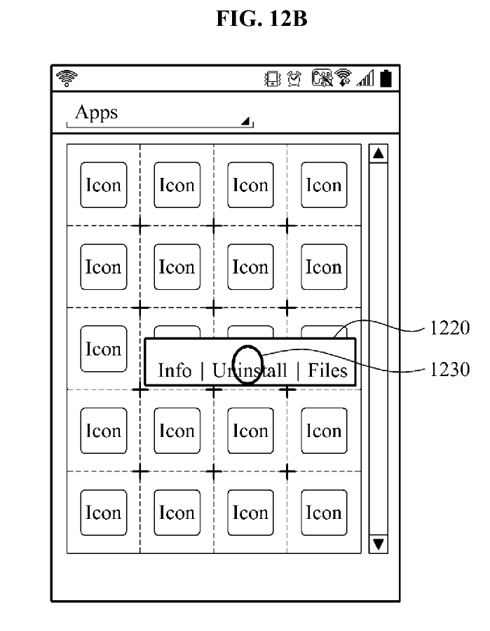

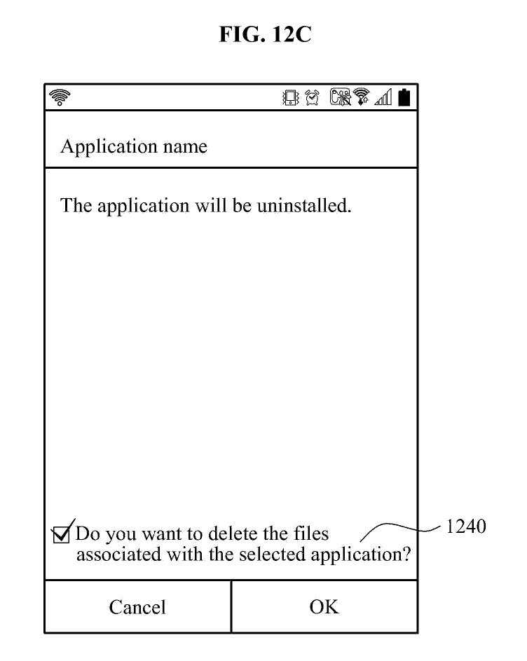

FIG. 12A, FIG. 12B and FIG. 12C illustrate a user interface when a terminal to process a file associated with an application deletes an application on a page for editing a plurality of applications according to exemplary embodiments.

Referring to FIG. 12A, applications currently installed in the terminal may be verified on a screen for editing a plurality of applications. However, aspects need not be limited thereto such that fewer than all of the applications or a subset of the applications installed in the terminal may be verified on the screen.

In response to an input 1210 associated with an application 1212 from a listing of applications, a shortcut menu 1220 of the selected application 1212 may be displayed as illustrated in FIG. 12B. The shortcut menu 1220 may include menus for selecting information (Info), a deletion (Uninstall), a file or a folder (Files) accessed by the selected application 1212. In response to a user input 1230 recognized on “Files” in the shortcut menu 1220, files or folders accessed by the application 1210 may be displayed in a message 1240 as illustrated in FIG. 12C. For example, the message 1240 may inform a user of files associated with the selected application and confirm deletion. For example, the message 1240 may state, “Do you want to delete the files associated with the selected application?”

In addition, in response to the user input 1230 recognized on “Uninstall” in the shortcut menu 1220, a separate page including a list of files or folders associated with the application 1212 may be displayed. On the displayed separate page, a portion of the files or the folders may be selectively deleted based on the user input.

In the related art, in the case of removing, that is, uninstalling an application from a terminal, only an application execution file may be deleted. According to exemplary embodiments, it is possible to verify a file and a folder created and executed by the application, and to delete, from the terminal, the file or the folder associated with the application when uninstalling the application from the terminal.

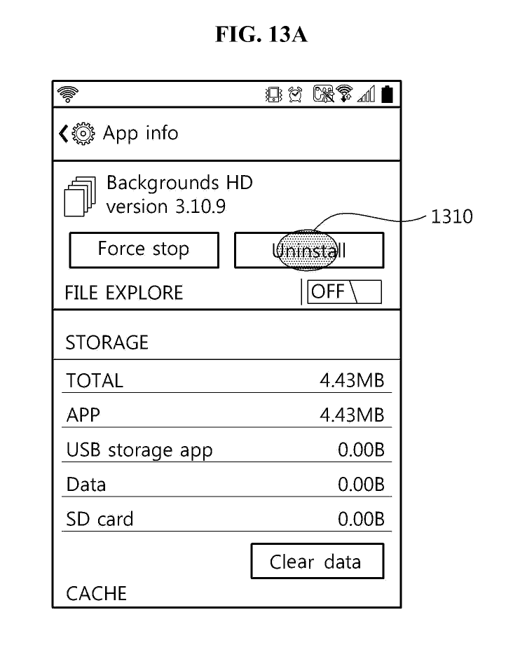

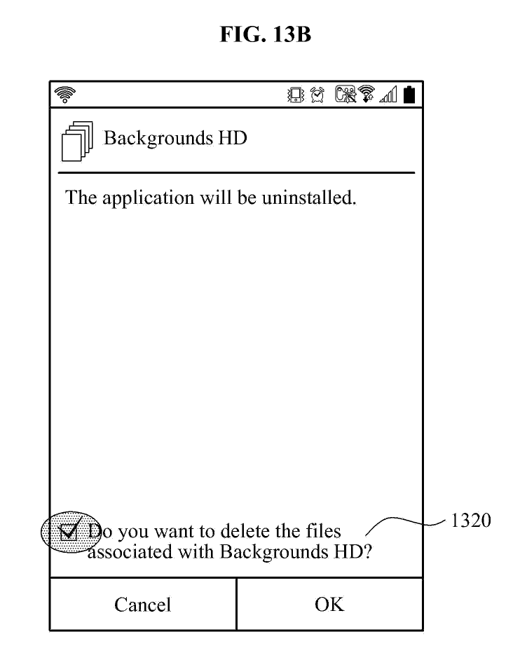

FIG. 13A and FIG. 13B illustrate a case in which a terminal for processing a file associated with an application deletes an application being executed according to exemplary embodiments.

In response to a deletion input 1310 of an application on an application information page of FIG. 13A, a check box 1320 asking, for example, “Do you want to delete the files associated with Backgrounds HD?” may be displayed as illustrated in FIG. 13B.

The present teachings provide a technology of recording a correlation between an application and a file or a folder during an access process of the application, and thereby determining an ownership with respect to each of applications installed in a terminal. The access process can include file operations, such as reading, writing, and deleting the file and the folder. By grouping files and folders based on an application having a corresponding ownership, it is possible to display the grouped files and folders on a screen of the terminal. Also, the present teachings provide a technology capable of managing files and folders within the terminal based on an application.

The exemplary embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal to process a file, the terminal comprising:
a display request determiner configured to determine whether to request displaying of a file or a folder associated with an application;
a database processor configured to manage an ownership database configured to map the file or folder with the application;
a file access controller configured to control access to the file or folder based on the ownership database; and
a display unit configured to display information about the file or folder,
wherein the file access controller grants access to the displayed information.

2. The terminal of claim 1, wherein the access is selected from one or more of installation, creation, or execution of the file or folder.

3. The terminal of claim 1, wherein the file access controller creates, if necessary, a mapping, in the ownership database, of the file or folder to the application accessing the file or folder, and setting a count of access for the application accessing the file or folder.

4. The terminal of claim 1, wherein the file access controller comprises an ownership determiner configured to determine an owner application for the file or folder based on a mapping of the file or folder to each application accessing the file or folder, wherein the mapping comprises a count of access by the application.

5. The terminal of claim 4, wherein the owner application is selected from each application accessing the file or folder, wherein the owner application has a largest count of accesses to the file or folder when compared to a count of accesses by other applications accessing the file or folder.

6. The terminal of claim 4, wherein the owner application comprises each application accessing the file or folder, and each application having an ownership priority ordered by the count of access to the file or folder by the respective application.

7. The terminal of claim 4, wherein an application creating the file or folder is provided a count of access greater than one at file creation.

8. The terminal of claim 4, wherein the file access controller further comprises a right granter configured to grant the application a permission to delete a file or folder, when the application is determined to be the owner application by the ownership determiner.

9. The terminal of claim 8, wherein the file access controller further comprises a deletion processor configured to delete the file or folder when the right granter grants the application a permission to delete a file or folder.

10. The terminal of claim 1, further comprising a search unit configured to search the ownership database for the file or the folder associated with the application.

11. A method for processing a file, the method comprising:
determining whether to request displaying of a file or a folder associated with an application;
storing in an ownership database a mapping of the file or folder with the application;
controlling access to the file or folder based on the ownership database; and
displaying information about the file or folder.

12. The method of claim 11, wherein the access comprises installation, creation, and execution of the file or folder.

13. The method of claim 11, further comprising creating, if necessary, a mapping, in the ownership database, of the file or folder to the application accessing the file or folder, and setting a count of access for the application accessing the file or folder.

14. The method of claim 11, further comprising determining an owner application for the file or folder based on a mapping of the file or folder to each application accessing the file or folder, wherein the mapping comprises a count of access by the application.

15. The method of claim 14, further comprising selecting the owner application from each application accessing the file or folder, wherein the owner application has a largest count of accesses to the file or folder when compared to a count of accesses by other applications accessing the file or folder.

16. The method of claim 14, further comprising selecting the owner application as each application accessing the file or folder, and each application having an ownership priority ordered by the count of access to the file or folder by the respective application.

17. The method of claim 14, wherein an application creating the file or folder is provided a count of access greater than one at file creation.

18. The method of claim 14, further comprising granting the application a permission to delete a file or folder, when the application is determined to be the owner application.

19. The method of claim 18, further comprising deleting the file or folder, when the application is determined to be the owner application.

20. The method of claim 11, further comprising searching the ownership database for the file or the folder associated with the application.
